(19) United States
(12) Patent Application Publication
(10) Pub. No.: US 2010/0212748 A1
(43) Pub. Date: Aug. 26, 2010

(54) SYSTEM AND METHOD FOR DETECTING AND PREVENTING FLUID LEAKS

(76) Inventor: John Andrew Davidoff, Phoenix, AZ (US)

Correspondence Address: MESCHKOW & GRESHAM, P.L.C., 7250 NORTH SIXTEENTH STREET, SUITE 318, PHOENIX, AZ, 85020-5279, US

(21) Appl. No.: 12/389,761

(22) Filed: Feb. 20, 2009

(51) Int. Cl. F17D 3/00

(52) U.S. Cl. 137/10; 137/487.5

(57) ABSTRACT

Systems and methods are provided for detecting and preventing fluid leaks. A rate of flow of a portion of fluid flowing through a fluid distribution network over a period of time is monitored. A determination is made whether the rate of flow of the fluid over the period of time is greater than zero but so low that it indicates a leak in the water pipe. If the rate of flow over the period of time indicates a leak, then the flow of the liquid through the system is stopped and an indication is provided that a leak has been detected.

### CROSS-REFERENCE TO RELATED APPLICATION

The present invention is related to “Systems and Methods For Detecting And Preventing Fluid Leaks” by John A. Davidoff, Ser. No. 11/133,737, filed 20 May 2005, which is incorporated herein by reference.

### TECHNICAL FIELD OF THE INVENTION

The present invention relates generally to detecting and preventing fluid leaks, more particularly, to detecting unwanted fluid flow through a conduit and stopping the unwanted fluid flow.

### BACKGROUND OF THE INVENTION

Unwanted water consumption caused by leaks in a pipe system, component failure, or a tap mistakenly left on must be detected to avoid extensive damage and cost. Unchecked amounts of water leaking into a home, office, or other similar building can cause damage to furniture, clothing, woodwork, artwork and other articles in the structure including damage to the structure itself. Moreover, water leaking into a structure can cause mold to grow in and around walls and floors, which can cause serious medical problems to individuals exposed to the mold for an extended period of time.

Currently available leak detection devices are capable of detecting potentially unwanted water consumption events. However, these leak detection devices are not capable of verifying whether the detected water consumption event is actually unwanted. Thus, these devices produce a number of false alarms. False alarms can be a nuisance to homeowners because false alarms may cause unnecessary shut off of water supply and unnecessary repair trips by maintenance personnel.

Moreover, many commercially available leak detection devices are unable to modify the types of events that are detected as unwanted water consumption events based on water usage of a particular residence. Instead, the detection devices use constant, preset parameters to determine whether a leak exists, without providing means for supplementing these parameters based on specific water usage of a particular residence.

Conventional leak detection systems are based on techniques that require significant fluid flow before the system recognizes that the event is not a normal water consumption event, but rather is a leak. In these systems, without this significant water loss it is difficult to distinguish between a normal water consumption event and an undesirable leak. This method of leak detection is undesirable, as the large leak required for detection often causes considerable property damage prior to detection.

Furthermore, conventional systems that are capable of detecting these large leaks are often incapable of detecting small leaks. Flowmeters and other devices that are able to obtain reasonable readings for a normal water consumption event are often unable to distinguish between a legitimate low water consumption event and a flow rate which is less than the legitimate level but still greater than zero. This limitation is due to the limited range over which a conventional flowmeter can indicate flow rates.

It is with respect to these considerations and others that the present invention has been made.

### SUMMARY OF THE INVENTION

In accordance with the present invention, the above and other problems are solved by systems and methods for detecting and preventing fluid leaks.

According to one embodiment of the method, a rate of flow of a fluid through a conduit over a period of time is monitored. A determination is made whether the rate of flow of the fluid over the period of time is greater than zero but otherwise so low that it indicates a leak in the conduit.

In accordance with another embodiment of the method, a rate of flow of a fluid through a conduit over a period of time is monitored. If there is no detected flow through the conduit, a pressure in the conduit is monitored. If the pressure in the conduit decreases, an indication is provided that a leak has been detected.

These and various other features as well as advantages, which characterize the present invention, will be apparent from a reading of the following detailed description and a review of the associated drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a block diagram of a system for detecting and preventing a fluid leak according to an embodiment of the present invention;

FIGS. 2A-2C are flow diagrams showing an illustrative process for detecting and preventing a fluid leak according to an embodiment of the present invention;

FIG. 3 is a block diagram of a system for detecting and preventing a fluid leak according to an alternate embodiment of the present invention;

FIG. 4 is a timing diagram depicting events which may occur in a fluid distribution network having no leaks;

FIGS. 5A-5C together present a flow diagram showing an illustrative process for detecting and preventing a fluid leak according to an alternate embodiment of the present invention; and

FIG. 6 is a timing diagram depicting events which may occur in a fluid distribution network where a leak is developing.

### DETAILED DESCRIPTION OF THE PREFERRED EMBODIMENTS

Embodiments of the present invention provide for systems and methods for detecting unwanted fluid flow through a conduit and stopping the unwanted fluid flow. When an unwanted fluid flow is detected, action is taken to stop the unwanted fluid flow and verify the existence of a leak or component failure in a pipe system. In the following detailed description, references are made to the accompanying drawings that form a part hereof, and in which are shown by way of illustration specific embodiments or examples. It should be understood that although the following description will be with respect to water flowing through water pipes in a structure, such as a home or building, the invention may be used to determine and prevent leakage of any fluid through pipes in any appropriate environment. Referring now to the drawings, in which like numerals represent like elements through the several figures, aspects of the present invention and the exemplary operating environment will be described.

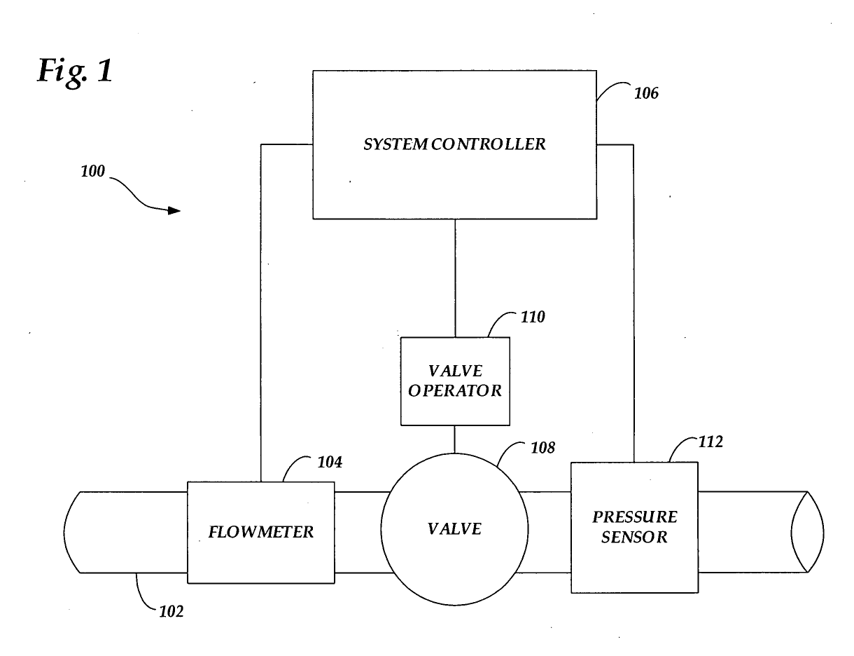

FIG. 1 is a block diagram of a system 100 for detecting and preventing water leaks including a flowmeter 104 connected to a water pipe 102 preferably downstream of a water supply pipe entry into a structure, such as a home. The flowmeter 104 may be of any suitable construction capable of measuring a rate of flow of a fluid flowing through the water pipe 102 and providing output data related to the rate of flow of the fluid to a system controller 106. Examples of other suitable devices include a rotating paddle wheel, a rotometer, an ultrasonic transducer, a differential pressure transducer, or any other known device for measuring a rate of flow of a fluid and providing output data related to the measured rate of flow.

The system 100 further includes a flow control device 108 connected to the water pipe 102. In an actual embodiment of the present invention, the flow control device 108 comprises a valve disposed downstream from the flowmeter 104. Alternatively, the flow control device 108 may be connected to the water pipe 102 upstream from the flowmeter 104. It should be understood that the flow control device 108 may be any suitable construction capable of stopping the flow of a fluid through the water pipe 102 in response to a signal communicated from the system controller 106. As later described, when the system controller 106 detects a leak in the water pipe 102, the system controller sends a signal to a valve operator 110 to close the flow control device 108 to prevent further flow through the water pipe.

A pressure sensor 112 is connected to the water pipe 102 downstream from the flow control device 108. The pressure sensor 112 may include any device operative to measure the pressure in the water pipe 102 and provide output data related to the pressure in the water pipe to the system controller 106. Examples of suitable devices include a strain gauge pressure sensor, a variable capacitance pressure sensor, a piezoelectric pressure sensor, or any other known device capable of measuring pressure and providing output data related to the measured pressure.

The system controller 106 is connected to the flowmeter 104, the valve operator 110, and the pressure sensor 112 via data lines as illustrated in FIG. 1. The system controller 106 includes a memory device for storing preset events and supplemental events that are used by a processor of the system controller in combination with output data received from the flowmeter 104 and pressure sensor 112 to determine if a leak in the water pipe 102 has occurred, as will be described below. The system controller 106 further includes a control panel for receiving data input regarding a rate of flow of water over a period of time and providing indications that a leak has been detected.

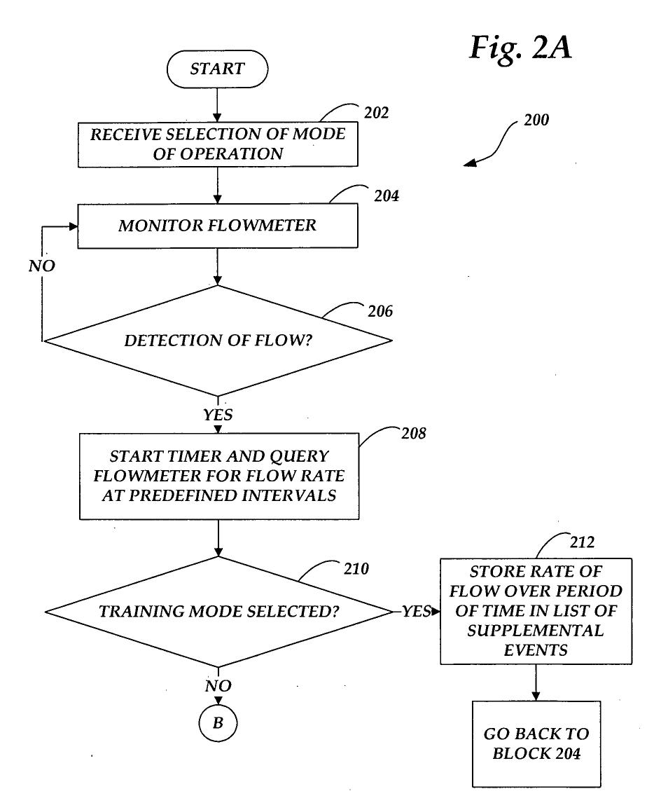

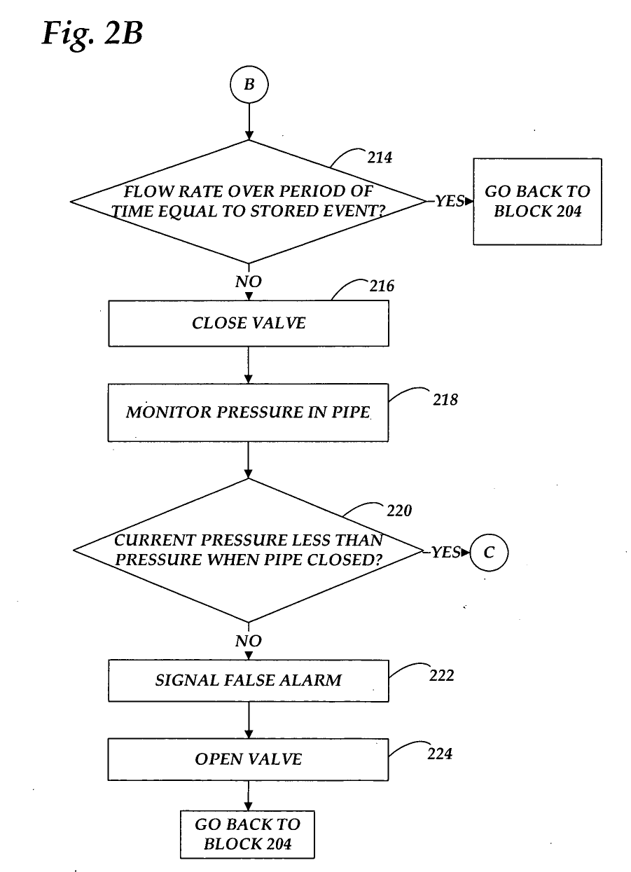

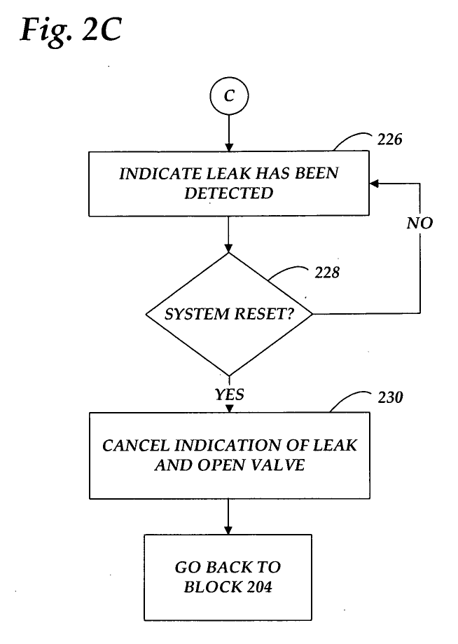

FIGS. 2A-2C illustrate a flowchart describing a process 200 for detecting and preventing a leak in a water pipe 102 of FIG. 1, according to an embodiment of the invention. The process 200 begins at block 202 where the system controller 106 receives a selection of a mode of operation. The system controller 106 includes various modes of operation which, when selected, allow for unique water consumption events, such as filling a pool or watering a lawn, without indicating that a leak has been detected. Each mode of operation is associated with a rate of flow of water over a period of time needed to complete that mode stored in the memory device of the system controller 106. For example, the mode of operation corresponding to filling a 3000-gallon pool is associated with a rate of flow of 3 gallons/minute over a period of 17 hours. The system controller 106 also includes a training mode which, when selected, indicates that the upcoming water consumption is a wanted consumption of water not currently stored in the list of events, as discussed further below. The control panel associated with the system controller 106 includes a set of light emitting diodes (LEDs) used to indicate which mode of operation has been selected.

From block 202, the process 200 proceeds to block 204, where the system controller 106 monitors the flowmeter 104 for a signal indicating that water is flowing through the water pipe 102. From block 204, the process proceeds to block 206 where the system controller 106 determines if the flowmeter 104 has sent a signal indicating a detection of flow through the pipe 102. When water is flowing through the water pipe 102, the flowmeter 104 detects the flow and sends an output signal to the system controller 106. If the system controller 106 has not received a signal from the flowmeter 104, then the process 200 proceeds back to block 204, where the system controller 106 continues to monitor the flowmeter 104. If, on the other hand, the system controller 106 has received a signal from the flowmeter 104, then the process proceeds to block 208, where the system controller 106 starts an internal timer and queries the flowmeter 104 for the rate of flow of the water through the water pipe 102 at predefined intervals such as, for example, every 15 seconds.

In another embodiment of the present invention, the system controller 106 may monitor the pressure sensor 112 to determine if water is flowing through the water pipe 102. When a faucet connected to the water pipe 102 is on or when a leak is present in the water pipe, water flows through the water pipe. When water is flowing through the water pipe 102, the pressure in the water pipe drops, causing the pressure sensor 112 to send an output signal related to the current pressure in the water pipe to the system controller 106.

If the system controller receives a signal from the pressure sensor 112, then the processor of the system controller 106 compares the current pressure in the water pipe 102 with the pressure in the water pipe when the water in the water pipe is not flowing, such as when the water pipe is closed, to determine if the current pressure is less than the pressure when the water is not flowing through the water pipe. If the current pressure is less than the pressure when water is not flowing through the water pipe 102, then the system controller 106 starts an internal timer and queries the flowmeter 104 for the rate of flow of the water through the water pipe 102 at predefined intervals, similar to the process 200 at block 208.

At block 208, the system controller 106 starts an internal timer and queries the flowmeter 104 for the rate of flow of the water through the water pipe 102 at predefined intervals. The system controller 106 continues to query the flowmeter 104 for the rate of flow of the water over a period of time and stores the values received from the flowmeter in the memory device associated with the system controller. From block 208, the process 200 proceeds to block 210, where a determination is made whether the training mode was selected. As discussed above, selection of the training mode indicates that the upcoming water consumption is a wanted consumption of water not currently stored in the list of events. If, at block 210, a determination is made that the training mode has been selected, then the process 200 proceeds to block 212, where the flow rate of the water over the period of time is stored in a list of supplemental events of water consumption events. After the flow rate of the water over the period of time is stored in the list of supplemental events, future flow rates of water over periods of time are compared to the events stored in the list of events as well as in the list of supplemental events. By using the supplemental events, the system 100 is able to more accurately determine a wanted water consumption event from an unwanted water consumption event for a particular residence. From block 212, the process 200 proceeds back to block 204, where the system controller 106 continues to monitor the flowmeter 104.

If, at block 210, a determination is made that the training mode has not been selected, then the process 200 proceeds to block 214, where a determination is made whether the rate of flow of the water over the period of time is equal to a stored event. The memory device of the system controller 106 includes a list of preset water consumption events that commonly occur inside a home as well as a list of supplemental events, as later described. For example, the list of events may include washing clothes, washing dishes, taking a shower, taking a bath, flushing a toilet, and any other water consumption event that commonly occurs inside a home or other structure. Each event on the list of events is associated with a rate of flow of water over a period of time typically needed to complete that event. For example, filling a toilet with water after it is flushed may be associated with a rate of flow of 1.5 gallons/minute for 15 seconds. The memory device of the system controller 106 also includes the rate of flow of water over the period of time associated with each mode of operation, as discussed above. At block 210, the processor of the system controller 106 compares the rate of flow of the water over the period of time with the rate of flow of water over the period of time associated with each event in the list of events as well as the rate of flow of water over the period of time associated with the selected mode of operation to determine if the rate of flow of water over the period of time is equal to the rate of flow of water over the period of time associated with one of the events. If the values are equal, then the current rate of flow of water over the period of time is considered a wanted water consumption event, and the process 200 proceeds to back to block 204, where the system controller 106 continues to monitor the pressure sensor 112. However, if a determination is made that the values are not equal, then the process 200 proceeds to block 216.

At block 216, since the system controller 106 has determined that an unwanted water consumption event has occurred, then the system controller sends a signal to the valve operator 110 instructing the valve operator to close the flow control device 108 so that further unwanted flow of water through the water pipe 102 is prevented. Once the flow control device 108 is closed, the process 200 proceeds to block 218, where the system controller 106 monitors the pressure in the water pipe 102 to verify that the unwanted flow of water detected is a leak. From block 218, the process 200 proceeds to block 220, where the processor of the system controller 106 compares the current pressure in the water pipe 102 with the pressure in the water pipe when the water in the water pipe is not flowing, such as when the water pipe is closed, to determine if the current pressure is less than the pressure when the water is not flowing through the water pipe. If the current pressure is less than the pressure when water is not flowing through the water pipe 102, then the process 200 proceeds to block 226. If, at block 220, a determination is made that the current pressure is not less than the pressure when the water is not flowing through the water pipe 102, then the process 200 proceeds to block 222, where the control panel associated with the system controller 106 provides an indication of a false alarm. The control panel associated with the system controller 106 includes a set of LEDs used to indicate the current status of the system 100. From block 222, the process 200 proceeds to block 224, where the system controller 106 sends a signal to the valve operator 110 to open the flow control device 108, and then the process 200 proceeds back to block 204, where the system controller 106 continues to monitor the flowmeter 104.

At block 226, where the system controller 106 provides an indication that a leak in the water pipe 102 has been detected. The system controller 106 uses the system status LEDs to indicate that a leak has been detected. The system controller 106 also provides an audible alert that will sound continuously for a predetermined amount of time, and if the system 100 is not manually reset by the conclusion of that predetermined amount of time, then the system controller 106 will sound the audible alert once every hour until the system is reset.

From block 226, the process 200 proceeds to block 228, where a determination is made whether the system 100 has been reset. If the system 100 has not been reset, then the process 200 proceeds back to block 226, where the audible alert continues to sound until the system is reset. If, at block 228, a determination is made that the system has been reset, then the process 200 proceeds to block 230 where indications that a leak has been detected are canceled, and the flow control device 108 is opened. The process 200 then proceeds back to block 204, where the system controller 106 continues to monitor the flowmeter 104.

In another embodiment of the present invention, the system 100 may actively seek out leaks in a pipe system associated with the water pipe 102 by periodically sending a signal instructing the valve operator 110 to close the flow control device 108. After the flow control device 108 closes, the system controller 106 signals the pressure sensor 112 to provide the pressure in the water pipe 102. The system controller 106 stores the current pressure in the memory device. After a predetermined amount of time, such as one minute, the system controller 106 signals the pressure sensor 112 to provide the pressure in the water pipe 102. The system controller 106 then compares the first pressure value received after the flow control device 108 is closed with the second pressure value received one minute after the flow control device is closed. If the values are the same, then the system controller 106 signals the valve operator 110 to open the flow control device 108. However, if the system controller 106 determines that the second pressure value is less than the first pressure value, then the system controller 106 provides an indication that a leak in the water pipe 102 has been detected. In an alternative embodiment, the system controller 106 signals the pressure sensor to provide the pressure in the water pipe 102, and the system controller 106 compares the current pressure with a stored pressure measurement taken when no water was flowing through the pipe 102. If the values are the same, then the system controller 106 signals the valve operator 110 to open the flow control device 108. However, if the current pressure is less than the stored pressure measurement, then the system controller 106 provides an indication that a leak in the water pipe 102 has been detected.

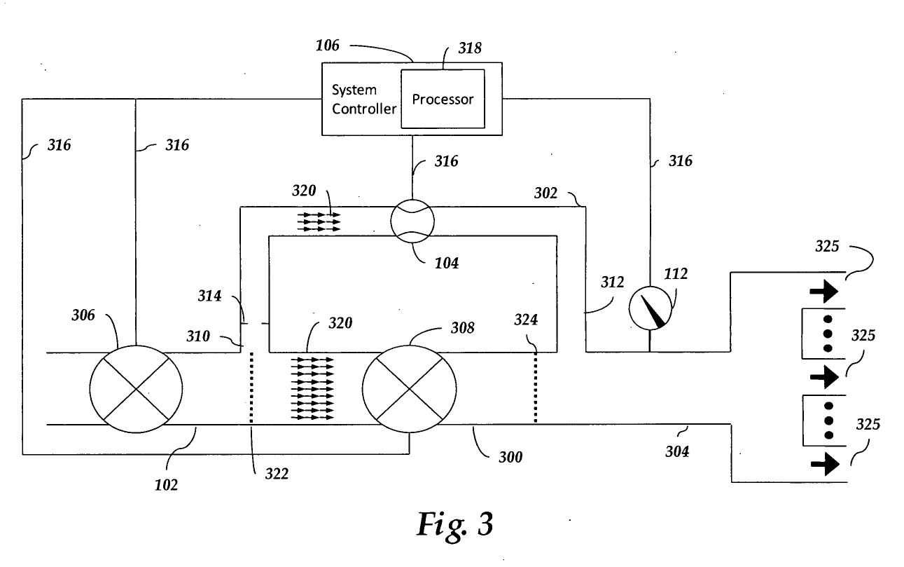

FIG. 3 is a block diagram of an alternative embodiment of system 100. In this embodiment, system 100 includes water pipe 102, designated as a first conduit 102, second conduit 300, a bypass flow control valve 308, a third conduit 302, a flowmeter 104, and a fluid distribution network 304. First conduit 102 includes a primary flow control valve 306, configured to control the flow of a fluid 320 to the remainder of system 100, including fluid distribution network 304. First conduit 102 is coupled to second conduit 300, which includes bypass flow control valve 308.

Fluid distribution network 304 is coupled to second conduit 300 and includes one or more conduits 325 configured to receive fluid 320 from second conduit 300 and third conduit 302. Although not shown, network 304 includes any number of appliances, valves, faucets, and the like each of which have an open state, in which fluid flows through fluid distribution network 304 and is put to some consumer use, and a closed state, which prevents fluid flow. When all such appliances, valves, faucets, and the like are in their closed states and when fluid distribution network 304 is experiencing no leaks, no fluid flows in fluid distribution network 304.

In one embodiment, fluid distribution network 304 defines the sole zone for a building, such as a typical single family residence of 3000 sq. ft or smaller. But nothing requires fluid distribution network 304 to be a used with any particular size or type of building. In another embodiment, fluid distribution network 304 is a single zone within a larger building or campus which has more than one zone. The use of multiple zones may be desirable in larger buildings, residences, a campus of several buildings, and the like, where the large total number of appliances, valves, faucets, and the like suggest that it would be less likely for all such appliances, valves, faucets, and the like in the large building or campus to be in their closed states for considerable periods of time during normal operation. In such an embodiment, multiple zones may couple together upstream or downstream from primary flow control valve 306. The use of multiple zones makes it more likely that all appliances, valves, faucets, and the like in any single one of the zones will be in their closed states for considerable periods of time during normal operation, and the use of multiple zones also helps identify the locations of small leaks when they first develop.

The alternative embodiment of system 100 depicted in FIG. 3 is configured to implement a different type of leak test than is described above. In particular, the FIG. 3 embodiment is based on the recognition that all legitimate water consumption events (i.e., uses of water that are not considered to be leaks) in fluid distribution network 304 should cause a flow of water at greater than some minimum legitimate rate of flow (discussed in more detail below). Thus, rates of flow above zero but less than this minimum legitimate rate of flow indicate or at least suggest the occurrence of a leak. For example, when a pipe has burst due to freezing, the initial stages of thawing will produce such a low flow rate leak even though larger flow rates may occur as thawing progresses. And, when a washing machine hose is in its beginning stages of failure, such a low flow rate occurs even though a greater flow rate may occur later when the hose fails completely. By detecting such low flow rates, leaks may be identified before an amount of fluid large enough to cause damage has been leaked.

The minimum legitimate rate of flow is related to the smallest individual flow rate associated with each of the appliances, valves, faucets, and the like in fluid distribution network 304. In a typical residential application, that smallest flow rate is likely to be an ice maker, but different fluid distribution networks 304 can have different smallest flow rates. A typical flow rate associated with a slow-filing ice maker may be around two ounces of water per minute, and this flow typically continues for a period of about five to fifteen seconds. Desirably, system 100 establishes the legitimate minimum flow rate for fluid distribution network 304 to be less than the smallest flow rate for network 304 so that false alarms are unlikely.

After establishing the minimum legitimate rate of flow, system 100 monitors the actual rate at which fluid flows into fluid distribution network 304. When system 100 confirms that fluid is flowing (i.e., at a rate greater than zero) but at a rate less than the legitimate minimum flow rate, the occurrence of a leak is indicated.

The leak test performed by this alternative embodiment may be performed in lieu of or in conjunction with the leak tests described above in connection with FIGS. 1 and 2A-2C.

Referring to FIG. 3, third conduit 302 has an upstream end 310 and a downstream end 312. The terms “upstream” and “downstream” refer to the direction of flow for fluid 320 during the normal operation of system 100, with first conduit 102 being upstream of second conduit 300, and primary flow control valve 306 being upstream of bypass flow control valve 308 and flowmeter 104. FIG. 3 depicts fluid 320 using a series of arrows which point in the downstream direction. Upstream end 310 is the end of third conduit 302 at which fluid enters third conduit 302, and downstream end 312 is the end of third conduit 302 at which fluid exits third conduit 302. Upstream end 310 of third conduit 302 couples to first and/or second conduits 102 and 300 downstream of primary flow control valve 306 and upstream of bypass flow control valve 308.

Second conduit 300 couples to fluid distribution network 304 at a juncture 324. Juncture 324 is defined to be located between bypass valve 308 and downstream end 312 of third conduit 302. No coupling or fitting is required at juncture 324. It is the point where fluid distribution network 304 is defined as beginning for the purposes of this description.

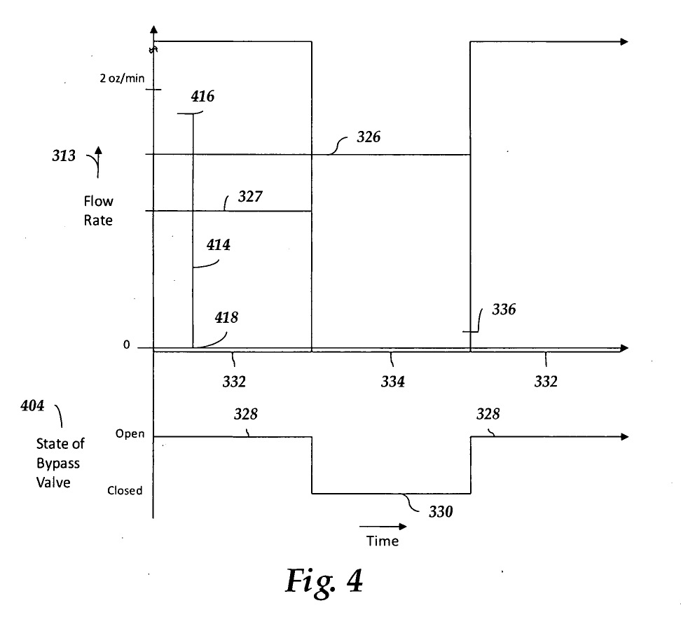

FIG. 4 is a timing diagram depicting events which may occur when fluid distribution network 304 has no substantial leaks. Referring to FIGS. 3-4, flowmeter 104 is positioned in third conduit 302 so as to measure a flow rate 313 of fluid 320 flowing through third conduit 302. Flow rate 313 indicates an instantaneous value for a quantity of fluid 320, typically expressed as a volume (e.g., ounces), which would pass through flowmeter 104 within a period of time (e.g., one minute) if the rate were to remain constant for that period of time.

Desirably, flowmeter 104 is a conventional, reliable, and inexpensive, flowmeter of a type well known to those skilled in the art. Such flowmeters are typically limited as to the range of flow that they measure. Desirably, flowmeter 104 is selected to reliably measure flow rates less than 2 oz/minute, while also being able to distinguish such flow rates from substantially zero flow. In one embodiment, flowmeter 104 may measure fluid flow over the range of 0.1-2.5 oz/minute, but this is not a requirement of the present invention. If a minimum legitimate rate of flow 326 for fluid distribution network 304 is established either explicitly or implicitly to be around 0.7 oz/minute, which would be less than a typical flow rate for a slow-filling ice maker, such a flowmeter can reliably distinguish between a situation of no substantial fluid flow and flow at minimum legitimate rate of flow 326. Nothing requires flowmeter 104 to accurately measure flow rates as large as the smallest individual flow rate associated with the appliances, valves, faucets, and the like in fluid distribution network 304.

As a result of being able to distinguish such low flow rates, the higher flow rates associated with many if not all legitimate water usages, if permitted to flow through third conduit 302, might result in a flow rate beyond the rated capacity of flowmeter 104 possibly causing it to become damaged. To avoid this, third conduit 302 is configured to allow fluid 320 to flow within third conduit 302 at only a maximum rate which is less than the maximum rate specified for flowmeter 104.

Fluid flow through third conduit 302 may be controlled by the use of a small cross-sectional area of third conduit 302, regulating the amount fluid that can enter third conduit 302 at standard pressures. Further regulation of fluid quantity may be achieved by using a flow-limiting orifice 314. Flow-limiting orifice 314 reduces the cross-sectional area of the opening into third conduit 302, thus reducing the amount of fluid that can enter third conduit 302.

The portion of fluid 320 that does not flow through third conduit 302, flows through second conduit 300. Flow from first conduit 102 to fluid distribution network 304 through second conduit 300 is controlled by bypass flow control valve 308. Bypass flow control valve 308 is considered to be a bypass valve because it allows fluid 320 to bypass third conduit 302 and flowmeter 104 when bypass flow control valve 308 is in an open state 328.

In one embodiment, system 100 includes pressure sensor 112 for use as discussed above in connection with FIGS. 1 and 2A-2C. Pressure sensor 112 is placed downstream of primary valve 306, and measures the pressure levels in system 100. Although in FIG. 3 pressure sensor 112 is shown as measuring pressure in fluid distribution network 304, it should be noted that the pressure in fluid distribution network 304 can also be measured at any point in system 100 downstream from primary valve 306.

System controller 106 is connected to flowmeter 104, primary valve 306, bypass valve 308 and pressure sensor 112 via data lines 316. Although data lines 316 are shown as physical connections between system controller 106 and the components to which system controller 106 is connected, it is not necessary that there be a physical connection between the components. Any method of communication between these devices, either wired or wireless may be used to communicate between the components. System controller 106 includes a processor 318 that uses data received from flowmeter 104 and pressure sensor 112 to determine if there is a leak in fluid distribution network 304. In an embodiment that includes multiple zones, a single system controller 106 may monitor and control the multiple zones, where each zone has its own flowmeter 104, bypass valve 308, conduits 300 and 302, and fluid distribution networks 304.

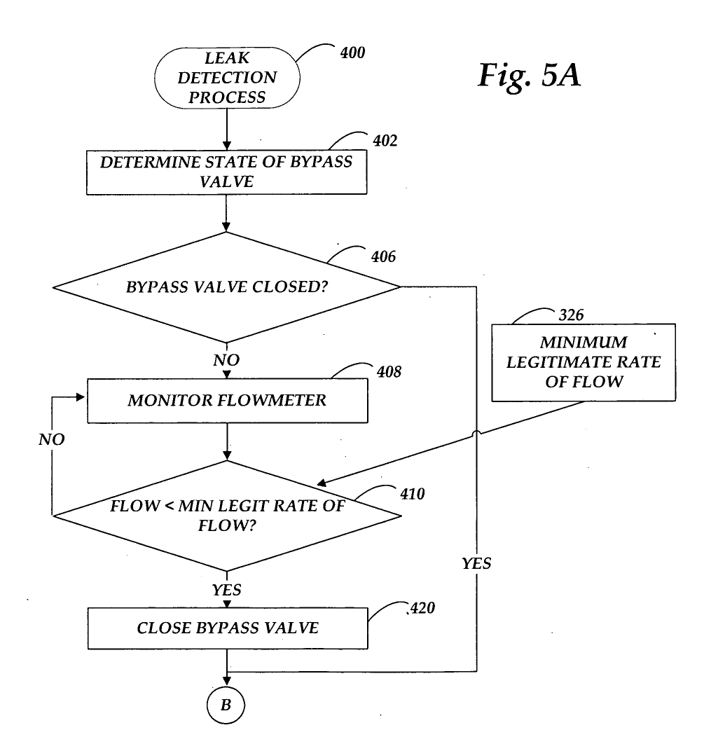

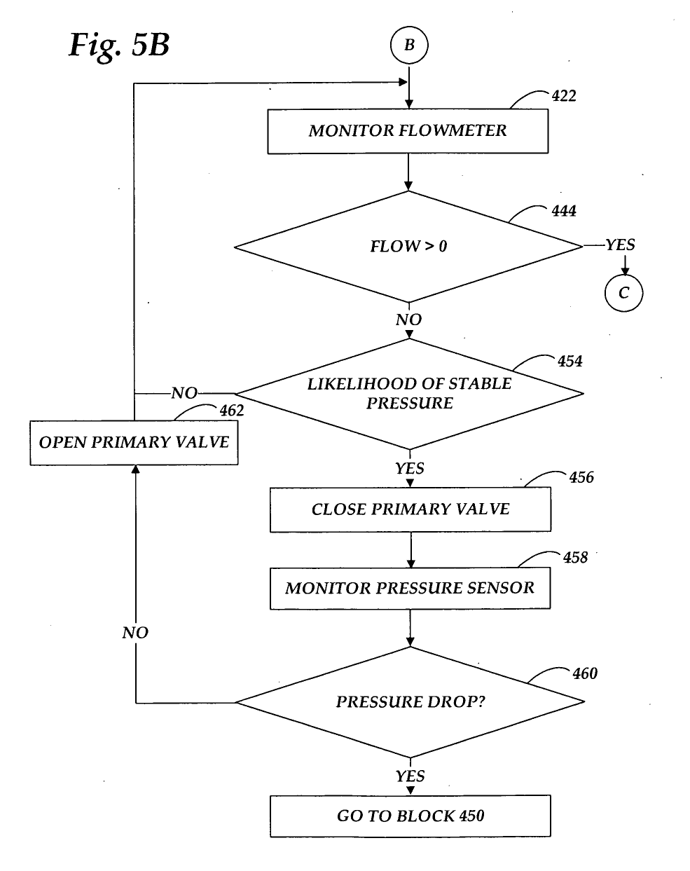

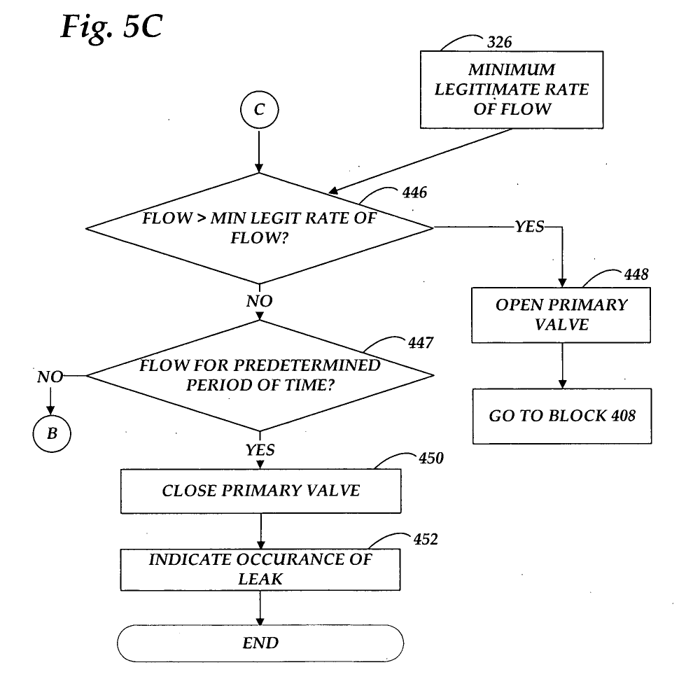

FIGS. 5A-5C illustrate a flowchart describing a process 400 for detecting leaks in fluid distribution network 304 of FIG. 3, according to one embodiment of this invention. Referring to FIGS. 3-5, process 400 may begin at a task 402 where system controller 106 determines a state 404 of bypass valve 308. Task 402 may establish state 404 as being either a closed state 330 or open state 328. After system controller 106 determines state 404 of bypass valve 308, process 400 proceeds to a query task 406. At query task 406, if bypass valve 308 is in open state 328, process 400 proceeds to a task 408, where system controller 106 monitors flowmeter 104. When task 406 determines that bypass valve 308 is in closed state 330, process 400 proceeds to a task 422, discussed below.

After system controller 106 receives data from flowmeter 104 in task 408 regarding flow rate 313, a query task 410 determines whether flow rate 313 is less than minimum legitimate rate of flow 326. More particularly, in this embodiment task 410 determines whether flow rate 313 is less than a close bypass valve threshold 327, which is less than minimum legitimate rate of flow 326. Tasks 408 and 410 occur while system 100 is in an open period 332, depicted in FIG. 4.

While minimum legitimate flow rate 326 may be established either explicitly or implicitly, it is established implicitly in the embodiment described herein. Although not a requirement, in the embodiment described herein minimum legitimate flow rate 326 is associated with the flow rates at which bypass valve 308 opens. In particular, in this embodiment, minimum legitimate rate of flow 326 is established equal to the minimum flow rate detected by flowmeter 104 and transmitted to system controller 106 when bypass valve 308 is closed for system controller 106 to signal bypass valve 308 to open. Close bypass valve threshold 327 is set below minimum legitimate rate of flow 326 by an amount sufficient to implement hysteresis and prevent valve 308 from oscillating off and on as flow rate 313 passes through rate 326 and threshold 327 during the normal operation of system 100.

In order to detect whether flow rate 313 is above or below minimum legitimate rate of flow 326, flowmeter 104 has a flow rate range 414 having an upper limit 416 and a lower limit 418. Upper limit 416 is greater than minimum legitimate rate of flow 326 to ensure that flowmeter 104 is able to reliably measure a flow rate 313 sufficient to signal system controller 106 to open bypass valve 308 without risking damage due to a flow rate beyond the rated capacity. Lower limit 418 is substantially zero such that flowmeter 104 is capable of reliability measuring very slow flow, substantially below minimum legitimate rate of flow 326 but just above zero. Once bypass valve 308 is open, flow rate 313 measured by flowmeter 104 then becomes less than the actual flow rate 313 for distribution network 304, as third conduit 302 accepts only a portion of the fluid flowing through system 100.

During tasks 408 and 410 bypass valve 308 is open, so flowmeter 104 reads only a fraction of the total flow through first conduit 102 and into fluid distribution network 304. The fractional value representing the proportion of fluid which passes through third conduit 302 and is measured by flowmeter 104 is known to system controller 106, so a multiplication operation by the inverse of this fractional value is performed in conjunction with task 410 to estimate the actual flow rate into fluid distribution system 304. If query task 410 estimates that the actual flow rate 313 for fluid distribution network 304 is greater than close bypass valve threshold 327, process 400 returns to task 408. It may be noted that any error in the measurement of fluid flow by flowmeter 104 during tasks 408 and 410 is amplified by the multiplication operation, and the resulting estimated flow rate for fluid distribution network 304 may not be highly accurate. But nothing requires great accuracy during tasks 408 and 410.

However, if query task 410 determines that flow rate 313 is less than close bypass valve threshold 327, process 400 performs a task 420, in which bypass valve 308 is closed by sending an appropriate data signal from system controller 106 to bypass valve 308. As a result, all fluid 320 flowing through first conduit 102 and into fluid distribution network 304 now passes through third conduit 302 and flowmeter 104. At this point, system 100 is in a closed period 334, depicted in FIG. 4.

After task 420, task 422 is then performed, in which system controller 106 monitors flowmeter 104 to determine if fluid 320 is flowing through third conduit 302. Following task 422, a query task 444 then uses the data received from flowmeter 104 by system controller 106 in task 422. In other words, tasks 422 and 444 determine whether the flow of fluid 320 into fluid distribution network 304 is substantially zero. And, since tasks 422 and 444 are performed with bypass valve 308 in its closed state 330, no multiplication operation need be performed to convert the reading from flowmeter 104 into a flow value for fluid distribution network 304. Any error present in the reading remains low because it is not amplified by a multiplication operation. Thus, tasks 422 and 444 are capable of making a reasonably accurate determination of whether the flow is substantially zero.

If task 444 determines that the fluid flow is greater than zero, then a query task 446 is performed to determine whether flow rate 313 is greater than minimum legitimate rate of flow 326. This situation occurs during a normal water consumption event, such as when an appliance, valve, faucet, or the like in fluid distribution network 304, activates to its open state to demand the delivery of fluid 320. When task 446 finds a flow rate greater than minimum legitimate rate of flow 326, a task 448 commands bypass valve 308 to its open state 328.

Desirably, bypass valve 308 is a fast acting valve designed to become fully open at task 448 before the flow rate through flowmeter 104 risks any damage due to flow rate being beyond its rated capacity and so that any restriction resulting from the closure of bypass valve 308 exerts no noticeable influence over the normal operation of fluid distribution network 304.

Following task 448, system 100 again enters its open period 332, and process 400 returns to task 408 to monitor for the end of open period 332. At this point, the full flow capability of system 100 is available to fluid distribution network 304, and flowmeter 104 is protected from damage due to flow rate being beyond its rated capacity because the bulk of fluid 320 is bypassing third conduit 302.

Recall that task 446 is performed when task 444 has detected a flow rate for fluid distribution system 304 greater than zero. When task 446 then determines that that this rate of flow is also less than minimum legitimate rate of flow 326, a query task 447 is performed.

Task 447 may be performed during normal operation at the instant that fluid distribution network 304 begins to engage in any routine water consumption event, at the instant that fluid distribution network 304 ends any routine water consumption event, or in response to random noise. Task 447 may also be performed when a leak occurs. To distinguish between the normal operation and the occurrence of a leak, task 447 causes system controller 106 to evaluate its internal timer to determine whether a predetermined period of time 336 has transpired since task 444 first detected fluid flow greater than zero. When period of time 336 has not transpired, process 400 returns to task 422 to continue monitoring flowmeter 104. FIG. 4 depicts the normal operation where system 100 moves to its open period 332 through the performance of task 448 before period of time 336 transpires. Predetermined period of time 336 is desirably greater than 1 second, and is greater than 5 seconds in the preferred embodiment.

Period of time 336 is set to provide sufficient time for flow rate 313 to become greater than minimum legitimate rate of flow 326 if the fluid flow results from normal operation and is not a leak. If flow rate 313 becomes greater that minimum legitimate rate of flow 326 within period of time 336, task 448 opens bypass valve 308, and process 400 returns to task 408.

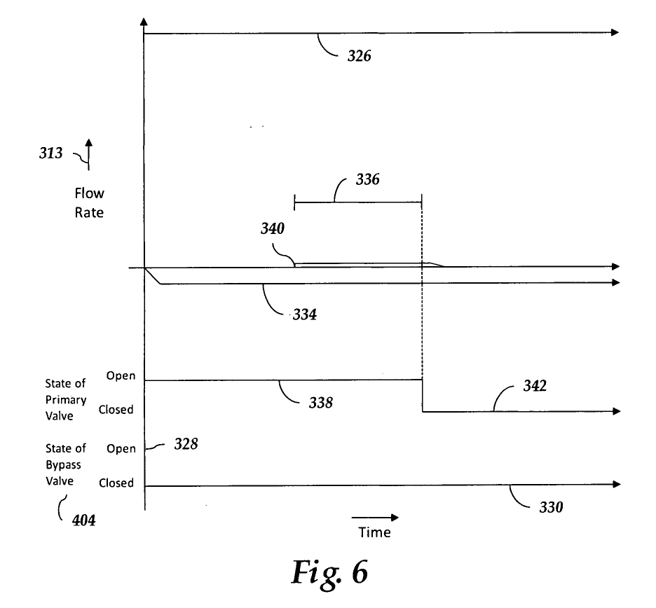

FIG. 6 is a timing diagram depicting exemplary events which may occur in fluid distribution network 304 where a leak is developing. FIG. 6 depicts events during closed period 334, where bypass valve 308 is in its closed state 330. FIG. 6 also depicts primary valve 306 as initially being in an open state 338, which is the normal operating state for valve 306. In the scenario depicted in FIG. 6, flowmeter 104 first depicts a flow rate greater than zero at a leak-initiation instant 340. In this scenario, the flow measured at flowmeter 104 neither exceeds minimum legitimate rate of flow 326 nor falls back to zero within predetermined period of time 336, indicating a developing leak. This situation is detected at task 447 (FIG. 5).

When task 447 determines the expiration of predetermined period of time 336, system controller 106 registers that a leak has been detected, and performs a task 450, where primary valve 306 is commanded to a closed state 342 to indicate the occurrence of the leak and to prevent the leak from progressing and causing property damage. A task 452 is then performed to further indicate the occurrence of a leak by flashing lights and/or sounding alarms. System 100 then waits to be reset.

Returning to query task 444, if flowmeter 104 does not register significant flow (i.e., registers a flow of substantially zero) through third conduit 302, a query task 454 is performed. Query task 454 determines whether conditions suggest a likelihood of stable pressure for a predetermined period of time sufficient to perform a pressure holding test, as discussed above in connection with FIGS. 1 and 2A-2C. Task 454 may make its determination by evaluating the time of day and conclude that conditions are unlikely unless it is in the middle of the night. Or, task 454 may make its determination by evaluating how long system 100 has been in its closed period 334 and conclude that conditions are unlikely unless several hours have transpired without exiting closed period 334. Or, task 454 may make any other determination which may be devised by those of skill in the art to indicate that pressure in system 100 is likely to remain stable for an upcoming period. And, task 454 may also conclude conditions are unlikely when a successful pressure test has been performed within a predetermined period, such as 24 hours. When task 454 concludes that stable pressures are unlikely in the near future, process 400 returns to task 422.

But when task 454 concludes that stable pressures are likely in the near future, a task 456 is performed to command primary valve 306 to its closed state 342. The closing of primary valve 306 isolates fluid distribution network 304 from the system that feeds first conduit 102. Next, during a task 458 system controller 106 monitors pressure sensor 112 for a drop in pressure in system 100. Then, a query task 460 uses data received by system controller 106 from pressure sensor 112 to determine whether a leak was detected. If a pressure drop is detected at task 460, process 400 performs task 450 to declare the event a leak. Although not shown, process 400 may also include tasks to verify that the drop in pressure is a real event prior to performing task 450, such as requiring system 100 to fail pressure tests for a predetermined number of times before declaring the event a leak. If no significant pressure drop is detected, process 400 performs a task 462 to command primary valve 306 to its open state 338 then returns to task 422.

While the embodiment described above in connection with FIGS. 3-6 depicts an implicit establishment of minimum legitimate rate of flow 326, minimum legitimate rate of flow 326 may also be explicitly established. Thus, minimum legitimate rate of flow 326 need not be equated to any threshold where bypass valve 308 is opened and/or closed for purposes of protecting flowmeter 104. Rather, depending on the specifications of the flowmeter 104, minimum legitimate rate of flow 326 may be set independently of any thresholds used in opening or closing bypass valve 308 and may be either greater than or less than such thresholds. Moreover, nothing prevents the embodiment described above in connection with FIGS. 3-6 from being used in conjunction with other leak-detection techniques, such as identifying when fluid 320 flows at a rate consistent with or greater than amounts typical of normal fluid consumption events but for such a long duration that an amount of fluid 320 too great for a normal fluid consumption event passes through fluid distribution network 304.

In summary, the present invention teaches systems and methods of detecting leaks in a fluid distribution network 304. Unlike conventional systems, system 100 is configured to detect a leak in fluid distribution network 304 without requiring a large volume of fluid 320 flow before determining a leak. Therefore, a leak can be detected in system 100 with very little flow of fluid 320, resulting in minimal property damage.

A system controller 106 is configured to receive data from a flowmeter 104 measuring a small portion of the total fluid 320 flowing through a conduit 102. Using the flow rate 313 received from flowmeter 104, system controller 106 estimates the total flow rate 313 through system 100. System controller 106 uses this to determine whether in fact a leak exists.

A pressure sensor 112 may also be used to further determine the occurrence of a leak. When the flow rate 313 of fluid 320 is determined to be zero, and at times where fluid use is expected to be minimal, pressure sensor 112 measures the pressure in fluid distribution network 304 and transmits this information to system controller 106. If system controller 106 detects a drop in pressure, system controller 106 registers that a leak exists.

After a leak is found, system controller 106 closes the primary flow control valve 306, thus preventing fluid 320 from flowing through system 100. This prevents any further damage to the property affected by the leak. An audible alert may also be used to alert a user to the presence of a leak.

Although the preferred embodiments of the invention have been illustrated and described in detail, it will be readily apparent to those skilled in the art that various modifications, such as the use of additional valves and flowmeters, may be made therein without departing from the spirit of the invention or from the scope of the appended claims.

What is claimed is:

1. A system for detecting leaks in a fluid distribution network (304), comprising:
a first conduit (102);
a second conduit (300) coupled to said first conduit (102), said second conduit (300) having a flow control valve (308) and said second conduit (300) being coupled to said fluid distribution network (304) downstream of said flow control valve (308);
a third conduit (302) having an upstream end (310), a flowmeter (104) and a downstream end (312), said upstream end (310) coupled to one of said first and second conduits (102, 300) upstream from said flow control valve (308), and said downstream end (312) coupled to said fluid distribution network (304), said third conduit (302) being configured to accept at least a portion of fluid flowing through said first conduit (102); and
a system controller (106) coupled to said flowmeter (104) and said flow control valve (308), said system controller (106) being configured to control a state (404) of said flow control valve (308) and to monitor said flowmeter (104) to determine whether a leak exists in said fluid distribution network (304).

2. The system of claim 1, wherein said flow control valve (308) is a second flow control valve (308), said system further comprising:
a first flow control valve (306) positioned in said first conduit (102);
a pressure sensor (112) downstream of said first flow control valve (306);
wherein said system controller (106) is coupled to said pressure sensor (112), and is further configured to monitor said pressure sensor (112) to determine whether a leak exists in said fluid distribution network (304).

3. The system of claim 1, wherein said system controller (106) is configured to determine whether a leak exists in said fluid distribution network (304) by determining whether a rate of flow (313) measured by said flowmeter (104) is less than a minimum legitimate rate of flow (326) and greater than zero for a predetermined period of time (336).

4. The system of claim 1, wherein said system controller (106) is configured to determine whether a leak exists in said fluid distribution network (304) by determining whether a rate of flow (313) measured by said flowmeter (104) is less than a minimum legitimate rate of flow (326) for a predetermined period of time (336).

5. The system of claim 4, wherein said minimum legitimate rate of flow (326) is less than two ounces per minute.

6. The system of claim 4, wherein said flowmeter (104) measures a rate of flow (313) over a range of flow rates (414), wherein an upper limit (416) of said range of flow rates (414) is greater than said minimum legitimate rate of flow (326) and a lower limit (418) of said range of flow rates (414) is substantially zero.

7. The system of claim 1, wherein said third conduit further comprises a flow-limiting orifice (314) upstream of said flowmeter (104).

8. The system of claim 1, wherein:
said flow control valve (308) is a second flow control valve (308);
said system further comprises a first flow control valve (306) positioned in said first conduit (102); and
said system controller (106) is further configured to control said first flow control valve (306) to a closed state (342) when a leak is determined to exist.

9. The system of claim 1, wherein said system controller (106) is configured to determine whether a leak exists in said fluid distribution network (304) by setting said flow control valve (308) to a closed state (330), and then determining whether a rate of flow (313) measured by said flowmeter (104) becomes greater than zero for at least a predetermined period of time (336) while said flow control valve is in said closed state.

10. The system of claim 9, wherein said predetermined period of time (336) is greater than one second.

11. The system of claim 1 wherein said system controller (106) is configured to determine whether a leak exists in said fluid distribution network (304) by determining whether a rate of flow (313) into said fluid distribution network (304) is less than a minimum legitimate rate of flow (326) but greater than zero for a predetermined period of time (336).

12. A method of detecting a leak in a fluid distribution network (304) comprising:
establishing a minimum legitimate rate of flow (326) for fluid flowing into said fluid distribution network (304);
monitoring (422) a rate (313) at which fluid flows into said fluid distribution network (304); and
indicating (450, 452) the occurrence of a leak when said monitoring activity detects fluid flowing at less than said minimum legitimate rate of flow (326) but greater than zero for a predetermined period of time (336).

13. The method of claim 12 further comprising:
determining when said rate (313) is substantially zero;
monitoring a fluid pressure when said rate (313) is substantially zero;
indicating the occurrence of a leak when said monitoring activity detects a decrease in said fluid pressure.

14. The system of claim 12, wherein said minimum legitimate rate of flow (326) is less than two ounces per minute.

15. The method of claim 12 wherein said indicating activity comprises preventing (450) said fluid from flowing into said fluid distribution network (304).

16. The method of claim 12, wherein said indicating activity comprises an audible alert (452).

17. A system for detecting leaks in a fluid distribution network (304), comprising:
a first conduit (102) having a first flow control valve (306);
a second conduit (300) coupled to said first conduit (102) downstream of said first flow control valve (306), said second conduit (300) having a second flow control valve (308) and said second conduit (300) being coupled to said fluid distribution network (304) downstream of said second flow control valve (308);
a third conduit (302) having an upstream end (310), a flowmeter (104) and a downstream end (312), said upstream end (310) coupled to one of said first and second conduits (102, 300) between said first and second flow control valves (306, 308), and said downstream end (312) coupled to said fluid distribution network (304), said third conduit (302) being configured to accept at least a portion of fluid flowing through said first conduit (102);
a pressure sensor (112) downstream from said first flow control valve (306); and
a system controller (106) coupled to said first flow control valve (306), said flowmeter (104), said second flow control valve (308) and said pressure sensor (112), said system controller (106) being configured to:
control a state of said first flow control valve (306); and
control a state (404) of said second flow control valve (308); and
monitor said flowmeter (104) and said pressure sensor (112) to determine whether a leak exists in said fluid distribution network (304).

18. The system of claim 17, wherein said system controller (106) is further configured to indicate the occurrence of a leak when either a rate of flow (313) measured by said flowmeter (104) is less than a minimum legitimate rate of flow (326) and greater than zero for at least a first predetermined period of time (336), or a pressure measured by said pressure sensor (112) decreases while said rate of flow is substantially zero.

19. The system of claim 17, wherein said minimum legitimate rate of flow (326) is less than two ounces per minute.
